(19) United States
(12) Patent Application Publication
(10) Pub. No.: US 2008/0228565 A1
(43) Pub. Date: Sep. 18, 2008

(54) Centralized Discount Searching

(75) Inventor: Ken Algiene, Highlands Ranch, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/685,676

(22) Filed: Mar. 13, 2007

(51) Int. Cl. B42D 15/00

(52) U.S. Cl. 705/14

(57) ABSTRACT

According to the invention, a system for providing a coupon to a user is disclosed. The system may include a host computer system and a computer readable medium. The computer readable medium may include instructions for receiving a characteristic information set from a plurality of businesses, where each characteristic information set includes at least one characteristic of a business; receiving a coupon set from each of the businesses, where each coupon set includes at least one coupon for a product or service; receiving a search request from a user interface, where the search request includes a characteristic or an identifier, and where the identifier represents a product or a service; selecting a first coupon from a first coupon set based on a comparison of at least some portion of the search request and at least some portion of the characteristic information sets or coupon sets; and transmitting the first coupon.

### BACKGROUND OF THE INVENTION

This invention relates generally to methods and systems for providing coupons to consumers. More specifically the invention relates to online systems which allow consumers to search coupons provided from businesses for those relating to specific goods and service desired by the consumer.

Coupons which provide discounts on goods and services when they are presented by consumers to businesses are traditionally provided in printed media such as magazines, newspapers, and newspaper advertisement inserts. Consumers typically must search these printed materials for those coupons which provide discounts on products which the consumer needs and/or desires. Those coupons typically must then be separated from non-coupon materials and saved until the specific time when the consumer desires to purchase the good or service. The time consuming nature of this process leads many consumer to forego using coupons, reducing their effectiveness to business as a method of increasing business. The systems and methods of the present invention provide solutions to these and other problems.

### BRIEF DESCRIPTION OF THE INVENTION

In one embodiment, a system for providing one or more coupons to a user is provided. The system may include a host computer system and a computer readable medium associated with the host computer system, where the computer readable medium comprises instructions executable by the host computer system. The instructions may include instructions for receiving a characteristic information set from each of a plurality of businesses, where each characteristic information set includes at least one characteristic of a business; receiving a coupon set from each of the plurality of businesses, where each coupon set includes at least one coupon for at least one product or service; receiving a search request from a user interface, where the search request includes at least one characteristic or at least one identifier, and where the identifier represents a product or a service; selecting a first coupon from a first coupon set based at least in part on a comparison of at least some portion of the search request and at least some portion of the characteristic information sets or some portion of the coupon sets; and transmitting the first coupon.

In another embodiment, a method for providing at least one coupon to a user is provided. The method may include receiving a characteristic information set from each of a plurality of businesses, where each characteristic information set includes at least one characteristic of a business; receiving a coupon set from each of the plurality of businesses, where each coupon set includes at least one coupon for at least one product or service; receiving a search request from a user interface, where the search request includes at least one characteristic or at least one identifier, and where the identifier represents a product or a service; selecting a first coupon based at least in part on a comparison of at least some portion of the search request and at least some portion of the characteristic information sets or some portion of the coupon sets; and transmitting the first coupon.

In another embodiment, a method for providing at least one coupon to a user and arranging appointments for that user is provided. The method may include receiving a characteristic information set from each of a plurality of businesses, where each characteristic information set includes at least one characteristic of a business; receiving a coupon set from each of the plurality of businesses, where each coupon set includes at least one coupon for at least one product or service; receiving a scheduling information set from each of the plurality of businesses, where each scheduling information set includes dates and times; receiving a search request from a user interface, where the search request includes at least one characteristic or at least one identifier, a date, and a time, where the identifier represents a product or a service; selecting a first coupon based at least in part on a comparison of the date, the time, and the characteristic or the identifier; and transmitting the first coupon.

### BRIEF DESCRIPTION OF THE DRAWINGS

The present invention is described in conjunction with the appended figures:

FIG. 1 is a block diagram of one possible system of the invention for providing one or more coupons to a user;

FIG. 2 is a block diagram of one possible method of the invention for providing one or more coupons to a user;

FIG. 3 is a block diagram of another possible method of the invention for providing at least one coupon and arranging appointments for a user; and

FIG. 4 is a block diagram of an exemplary computer system capable of being used in at least some portion of the systems of the present invention, or implementing at least some portion of the methods of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

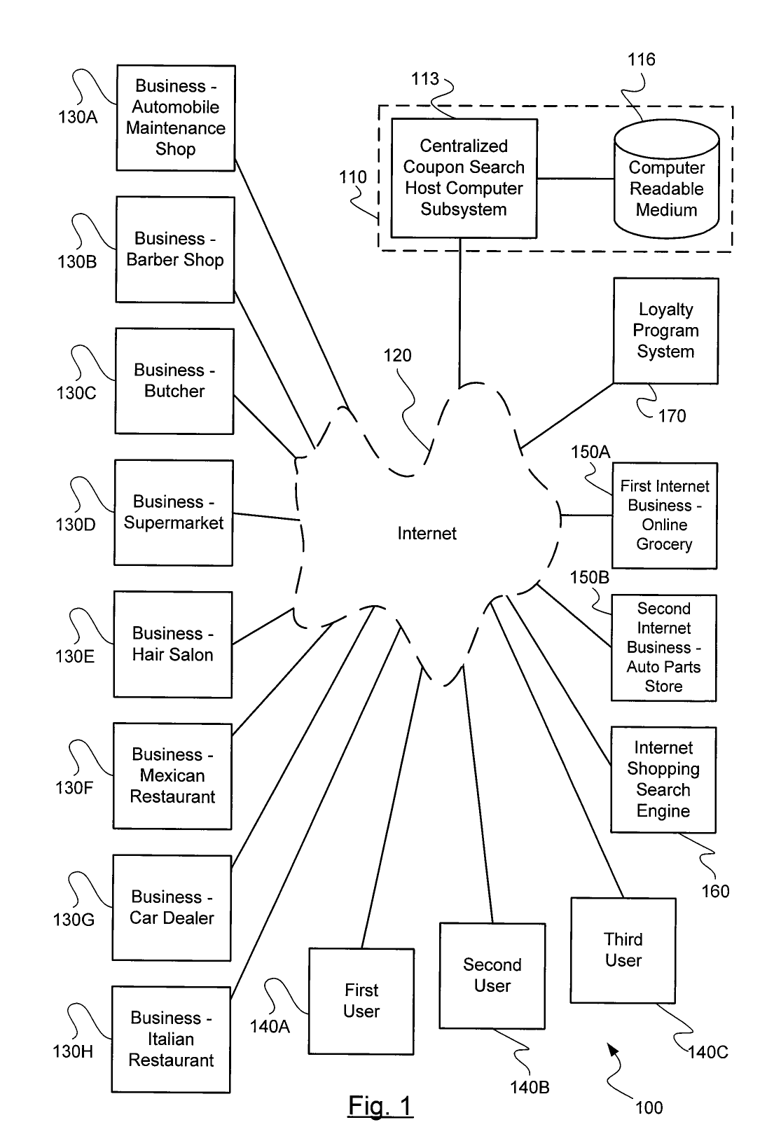

Turning now to FIG. 1, a block diagram of one possible system 100 for providing one or more coupons to a user is shown. System 100 may include a centralized coupon search system 110 having a host computer subsystem 113 in communication with a local computer readable medium 1 16. In other embodiments, computer readable medium 116 may be remote from centralized coupon search system 100, and either in direct or indirect communication therewith. Some possible indirect communication methods and include a local area networks, wide area networks and/or broader networks including the Internet 120.

Host computer subsystem 113 may be in communication with the Internet 120, allowing host computer subsystem 113 to communicate with businesses 130, users 140, Internet businesses 150, other Internet resources 160, and other electronic resources 170. Though the various components of the system 100 are shown being in communication with a host computer subsystem 113 via Internet 120, other communications methods are possible, including direct-connect systems and/or network connection systems. In some embodiments, communications from certain components, for instance businesses 130 or users 140, may be aggregated by other subsystems before being transmitted to/from host computer subsystem 113. In one example, one communication interface at centralized coupon search system 110 may coordinate all communications with businesses 130, and another communication interface may coordinate all communication with users 140.

Businesses 130 may include a variety of establishments, for example, merchants of goods, service providers, establishments that provide both goods and services, financial institutions, etc. In FIG. 1, various types of businesses are shown for purposes of illustration. A fewer or greater number of businesses could exist in any given embodiment. In instances where a business is an individual store or franchise location within a chain or corporate group of establishments, for example supermarket 130D, or hair salon 130E, each of the establishments may communicate with a centralized chain or corporate subsystem which then communicates with centralized coupon search system 110. In this manner, the chain or corporate subsystem may coordinate coupon offerings to users for all locations with the chain or corporation. This may be advantageous when different economic conditions (i.e. high or low supply and/or demand, or increased/decreased competition) in different geographic areas indicate that different coupon offerings should be made in different locations.

Users 140 may, merely by way of example, include any person, group, or organization which desires to access system 100 to obtain coupons for goods or services. A fewer or greater number of users could exist in any given embodiment. Users 140 may, merely by way of example, access system 100 via a personal computer, personal data assistant, mobile phone, landline phone, interactive television (i.e. via cable/satellite service) and/or public kiosk. Depending on the device used to access system 100, a graphical interface, possibly a web page through an Internet browser may be employed.

Internet business 150 may include any electronically accessible merchant or provider of services, for example, www.napaonline.com, www.amazon.com, www.etrade.com, and www.peapod.com. Internet shopping search engine 160 may include such online services as shopping.yahoo.com, www.pricegrabber.com, and www.shopzilla.com which compares and/or provides prices from any number of Internet businesses 150 for different products and/or services.

Loyalty program system 170 may include any system which coordinates loyalty programs for or by a business 130, chain of businesses 130, or other association of businesses 130. A loyalty program may reward customers of a business 130 or businesses 130 for purchases from the business 130. In one embodiment, a loyalty program may be associated with a particular business 130, while in other embodiments, groups of different business may share a common loyalty program. In yet other embodiments, purchasing methods may be associated with loyalty programs. Merely by way of example, a specific payment source such as a credit card account may have a loyalty program associated with it (i.e. cash back on purchases with the credit card). In some instances, specific payment source loyalty programs may have distinct awards for purchases made at certain businesses or for specific purchases during certain times (i.e. certain hotel chains; toy purchases during holiday seasons, etc.).

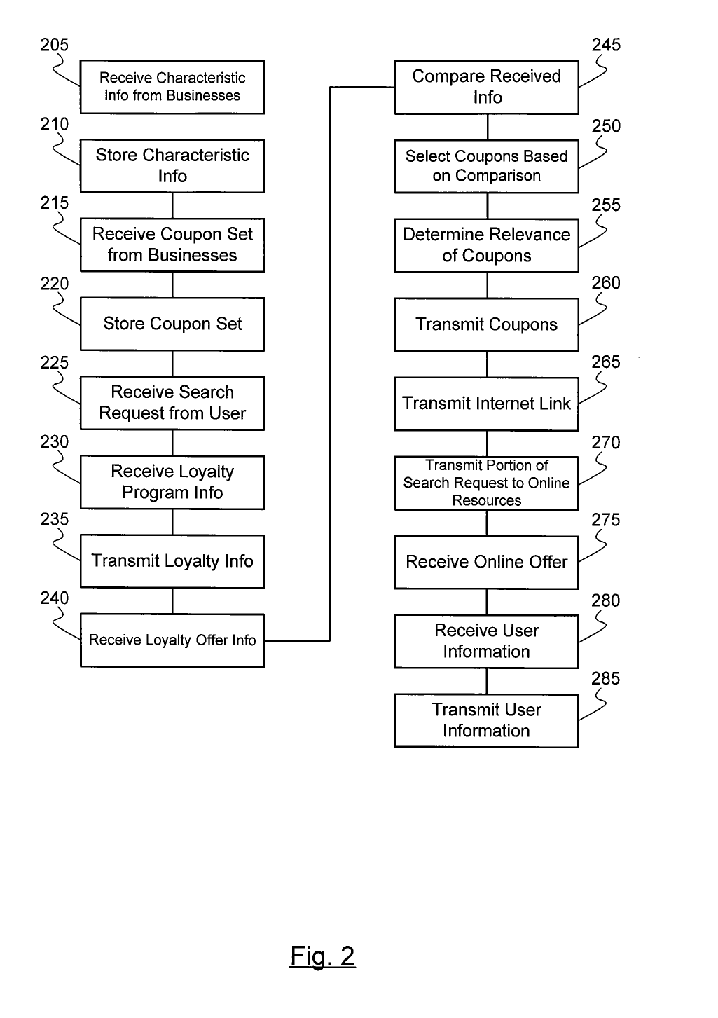

Turning now to FIG. 2, a flow diagram for a process of providing at least one coupon to a user is shown. At least some portion of the process shown in FIG. 2 may be stored on computer readable medium 116 and implemented by centralized coupon search host computer subsystem 113 in certain systems and/or subsystems of the invention.

At block 205, host computer subsystem 113 receives characteristic information from businesses 130. The characteristic information from each business 130 may include one or more of the following: a name, location, schedule of operating hours, phone number, e-mail address, fax number; and web site address. The characteristic information may include any other information related to business 130, especially information that might be useful and/or informative to a user 140 which may become a customer of business 130. In some instances, characteristic information for multiple locations of the same business 130 may be stored. The same characteristic information may also be used to determine which coupons to present to users 140 based on search requests received from users 140.

At block 210, host computer subsystem may store the received characteristic information, possibly at computer readable medium 116, which may be either local or remote from host computer subsystem 113. Note that in some embodiments, businesses 130 may directly access computer readable medium 116 and send characteristic information thereto.

At block 215, host computer subsystem 113 received coupon sets from businesses 130. The coupon sets from each business 130 may include individual coupons which are represented by information which entitles a user 140 to a discount on a product or service from a business 130.

Merely by way of example, a coupon in a coupon set may be a computer readable file which includes data configured to be printed in hardcopy form and presented to a business 130 for a discount on a product or a service. A user 140 may download such a coupon and print it from a personal computer or other device and then take it to the business 130 to redeem.

In another example, a coupon in a coupon set may be a computer readable file configured to be stored on a computer readable medium and presented to a business 130 for a discount on a product or a service. In this example, the coupon may be downloaded and stored by the user 140 on a flash drive, personal data assistant, mobile phone, smartcard, or other electronic device so it may be presented and read by a compatible system at the business 130 to obtain the discount. One such device is disclosed in U.S. Provisional Patent Application No. 60/833,022 entitled “Mobile Payment Device with Magnetic Stripe,” which is hereby incorporated by reference as if fully set forth herein for all purposes. In some embodiments, the electronic device may interpret the computer readable file and transmit a RFID signal representative of the coupon once the user 140 is at the business 130 and in range of a business 130 associated RFID transceiver.

In another example, a coupon in a coupon set may be a facsimile transmission which may include text or graphics. The configured to be presented to a business for a discount on a product or a service. The facsimile may be received by a user 140 facsimile device, personal computer, or service which receives facsimiles and translates them to another form, perhaps e-mail, and retransmits them to user 140. The facsimile may be printed and taken to the business 130 for a discount on a product or a service. IN some embodiments, the business may directly receive the facsimile and hold it for use by the user 140 once they arrive to complete the transaction.

In another example, a coupon in a coupon set may be a computer readable file configured to be received by a business 130 for a discount on a product or a service for a user 140. In these embodiments, the computer readable file may be received by the business 130 and stored for reference when the user 140 arrives to complete the transaction. In some embodiments, the systems operated by the businesses 130 which receive the coupons may be the same as, or in communication with, the systems which track inventory/requisitioning/acquisition, the systems which consumer loyalty program information 170, and/or track other financial information.

Merely by way of example, when a coupon is received for a certain good, an inventory system may reduce inventory for that good by either a requested or anticipated number of goods that will be subject to the transaction; a requisitioning system may identify that the goods as being on hold for an anticipated purchase; an acquisition system may determine to order more of the goods to replenish inventory; a loyalty program may be notified of a purchase by the user; and an accounting system may record the financial impacts of the anticipated sale. In other embodiments, certain aspects of the anticipated transaction, for example the financial impacts, may not be recorded by other systems until the transaction is actually consummated. In some embodiments, similar processes could occur merely upon receipt of the coupon during consummation of the transaction rather than specific electronic communications beforehand.

At block 220, host computer subsystem may store the received coupon sets, possibly at computer readable medium 116, which may be either local or remote from host computer subsystem 113. Note that in some embodiments, businesses 130 may directly access computer readable medium 116 and send coupon sets thereto. The coupon sets received from a business 130 will be associated, or associate-able, with the characteristic information previously received from businesses 130.

Therefore the computer readable medium or mediums 116 will now have characteristic information from a possible plurality of businesses 130, and at least one or more coupon in a coupon set from each of those same businesses 130. In some instances, a business 130 may not have any current coupons stored at computer readable medium 116, but the characteristic information will remained stored so that it will not need to be required and stored should the business 130 send new coupons at a later time. Note that in various embodiments, businesses 130 may regularly or irregularly update their available coupons, modifying the contents of computer readable medium 116.

At block 225, a coupon search request may be received by host computer subsystem 113 from a user 140. The search request may include any number of parameters the user 140 wishes the host computer subsystem 113 to use to find the most closely related coupons to those which the user 140 desires. The search parameters may include at least one characteristic or at least one identifier, where the identifier represents a product or service. The characteristic or characteristics may include information of a type specified and stored above for the various businesses 130, including, but not limited to a name, location, and/or schedule of operating hours. Merely by way of example, a search request may include the location of the user 140 sending the search request, a location the user may wish to make a purchase, a time of day the user wishes to complete the purchase of good or service at the business 130, a name of a merchant or provider of services, a desired discount and/or a price.

At block 230, loyalty program information may be received by host computer subsystem 113 from user 140. This information may consists of a member number or other identifier which correlates user 140 with a certain customer loyalty program. In some embodiments, association with a specific payment method, such as a credit or debit card may constitute loyalty program information. For example, a particular business 130 may provide discounts to users 140 if they use a certain bank's credit card. These arrangements may be arranged between the business 130 and the bank in an attempt to increase business at the merchant, and/or revenue generating use of the credit card for the bank. At block 235, the loyalty information may be transmitted to loyalty program system 170, and at block 240, loyalty offers available to user 140 based on the loyalty program information may be received by host computer subsystem 113 from loyalty program system 170. The loyalty offers may be equivalent or translatable to coupons which are also discounts on products or services. Host computer subsystem 113 may be configured to translate such discount offers and produce coupons in a format similar to and/or compatible with other coupons regularly presented to business 130.

At block 245, host computer subsystem 113 may compare at least a portion of the search request received from user at block 225 with the characteristic information and/or coupon sets received from businesses 130 at block 205 and block 215 and the loyalty offers received at block 240. At block 250, one or more coupons may be selected by the host computer subsystem based on the comparison made at block 245.

In some embodiments, the coupons selected may be any that have the same or similar characteristic information of the business 130 associated with coupons as specified in the search request. In some embodiments, the search request may specify certain required characteristics and/or preferable characteristics. In these embodiments, only coupons from businesses 130 with the required characteristics will be selected. Furthermore, while some characteristics in the search request may be explicitly selected by user 140, other characteristics in the search request may be set implicitly or by default. Merely by way of example, users 140 of system 100 may be required to, or at least optionally, provide home location information to host computer subsystem 113. All search requests coming from particular users may then be limited geographically to businesses 130 in a limited surrounding geographic area, unless otherwise instructed by user 140.

As referred to above, a search request may also include an identifier which represents a product or service the user 140 is seeking. As with characteristics, identifiers may contain multiple pieces of information regarding the product or service user 140 is seeking. Merely by way of example, identifiers may include a brand, product size, generic product name, etc. In an example where a search request included the preferred identifiers ‘Brand X’ and ‘spaghetti,’ coupons might be selected for pasta available at various businesses selected via the characteristic information in the search request. Some of the coupons selected may be for Brand X spaghetti, some may be for other types of Brand X pasta, some may be for spaghetti with other branding, and yet others may be for pasta with other branding. In another example where the search request included a preferred identifier of ‘Brand X’ and a required identifier of ‘spaghetti,’ only coupons for spaghetti would be presented, with some being from Brand X, and others being branded otherwise. In yet another example, the search request may only include required identifiers, and the search request for ‘Brand X’ ‘spaghetti’ would only return coupons for Brand X spaghetti, albeit possibly from different businesses 130 that fit the characteristic information in the search request.

At block 255, the host computer subsystem 113 may determine the relevance of each selected coupon. Relevance for each coupon may be determined, at least in part, on how many of the preferred characteristics and/or identifiers in the search request match the coupons and their associated business 130 characteristics. In some embodiments, a user 140 device, possibly a computer used by user 140 to access system 100 may determine the relevance of coupons.

At block 260, host computer subsystem 113 transmits the selected coupons. As discussed above, in some embodiments the coupons will be transmitted to user 140, while in other embodiments, the coupons will be transmitted to business 130. When the coupon or coupons are transmitted to business 130, a user may select which coupons are actually transmitted to the business after selecting one of the coupons.

In embodiments where multiple coupons are transmitted, the host computer subsystem 113 may transmit the coupons in order or relevance. The coupons may then be displayed by order of relevance for the user 140 to select which coupon or coupons are desired. In other embodiments, host computer subsystem 113 may determine the order that the coupons by relevance and create a data file with sorting information that may also be transmitted to user 140 so that the display of the coupons for selection by user can be accomplished at the user 140 device. At block 265, host computer subsystem 113 may also transmit links to Internet sites associated with the businesses 130 or products related to the coupons.

In some embodiments, at block 270, host computer subsystem 113 may transmit at least a portion of the search request to one or more online resources. As discussed above, online resources may include Internet resources such as Internet shopping search engines 160 and internet businesses 150. Upon receiving at least a portion of the search request, the Internet businesses 150 or Internet shopping search engine 160 may select various available online offers for the product or service for which user 140 is looking for coupons. Internet businesses 150 may themselves provide offers, while Internet search engine 160 may search multiple Internet businesses 150 for offers. These online offers may be received by host computer subsystem 113 at block 275, for re-transmittal to user 140. User 140 may then compare the available coupons with the online offers and select one. If user 140 selects an online offer, host computer subsystem 113 may redirect user 140 interface to the Internet business 150 associated with the selected offer. In another embodiment, a link to Internet business 150 may merely be presented. The operator of the host computer subsystem 113 may receive a fee from Internet business 150 for directing users 140 to Internet business 150 or for sales completed in this manner.

At block 280, host computer subsystem 113 may receive user information such as a name, phone number, payment information, and/or an address from user 140. As is the same with all other steps discussed herein, this step may occur either later or earlier than described in the example processes discussed herein. In some embodiments, this information may be used to either initiate or complete a business transaction prior to the user taking delivery of the product or services purchased. At block 285, the user information may be transmitted to any of the entities described herein, for example, businesses 130, Internet businesses 150, Internet shopping search engine 160 or loyalty program system 170. Other types of user information that may be receiver from user 140 include a coupon selection, and/or a counter-offer. A coupon selection will provide host computer subsystem 113 with direction as to which coupon to transmit to either user 140 or business 130. In some embodiments, a counter-offer may be received by host computer subsystem 113 and re-transmitted to business 130 for determination by business 130 if the counter-offer proposed by user 140 for goods or services will be accepted. In some embodiments, upon evaluation of the counter-offer, either an acceptance, a declination, or a counter-counter-offer may be transmitted from business 130 to host computer subsystem 113. This response may then be transmitted to user 140. User 140 may then agree to the counter-counter-offer, or the process may repeat itself until either user 140 or business 130 provides a final declination.

In another embodiment of the invention, user 140 may provide user information to host computer subsystem 113 in the form of a date a time. The date and time may specify which time user 140 wishes to complete the transaction and take delivery of the goods or receive the service selected.

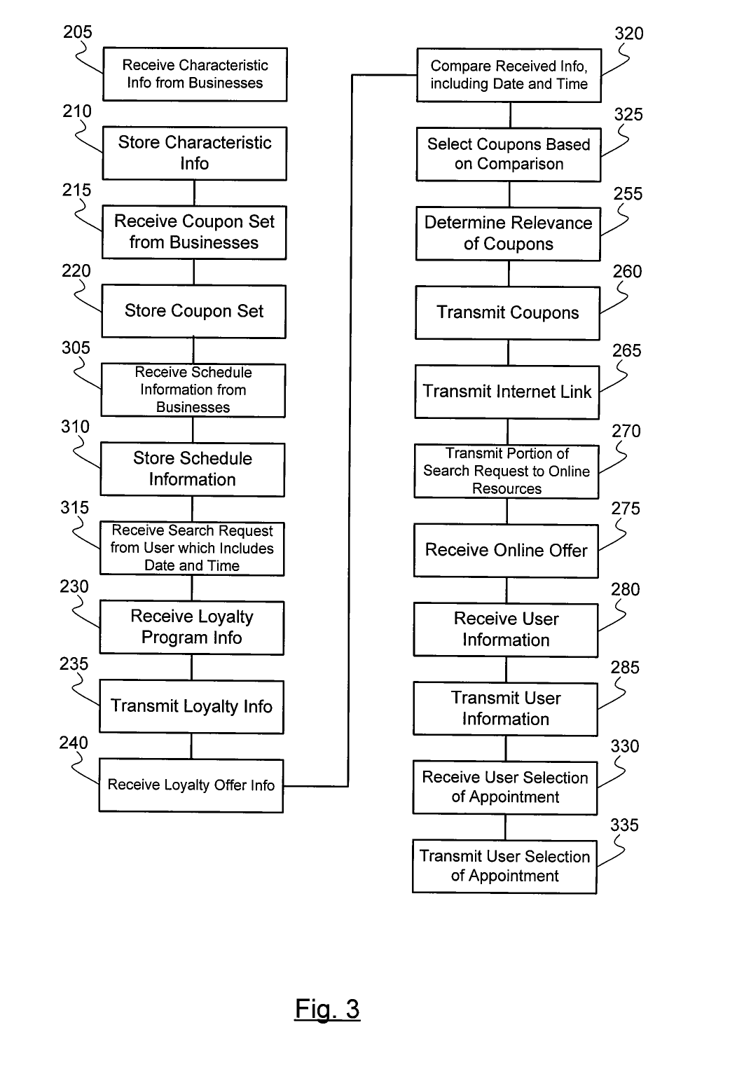

In another embodiment of the invention, a method for providing at least one coupon to a user 140 and arranging appointments for that user 140 is provided. As shown in FIG. 3, the method may include similar steps to those discussed with regard to FIG. 2. However, in these embodiments, at block 305 host computer subsystem 113 may receive scheduling information from businesses 130. The scheduling information may allow host computer subsystem 113 to determine when a particular business 130 has an available time to meet with a user 140 to discuss or consummate a sale. At block 310, this scheduling information may be stored, possibly at computer readable medium 116.

At block 315, and similar to the process discussed in FIG. 2, a search request from a user 140 may be received, except it will also, in this embodiment, contain a date and a time. This date and time may be a date a time which user 140 desires to discuss or consummate a sale of good or service for which coupons are being searched for by user 140. In some embodiments, multiple possible dates and times may be specified by user 140, and a level of preference for each may be selected.

At block 320, host computer subsystem 113 may compare at least a portion of the search request received from user 140 with the characteristic information, coupon sets, and schedule information received from businesses 130, and select a coupon based on such comparison at block 325. This is similar to the process described above in relation to FIG. 2, except coupons will be selected also based in part on comparison of the search request's date and time, and the schedule information from each of the businesses 130. Like all characteristics and identifiers (which specify a product or a service) in a search request, an exact match between the date and time in a search request and the schedule information of a particular business 130 is not required, unless a time and/or date are selected by the user to be flagged as ‘required’ in the search request. Dates and times in a search request from a user 140 which are only flagged as ‘preferred’ will cause host computer sub-system 113 to seek matches in coupons from businesses 130 with the same or as close to matching scheduling information as in the search request. Business 130 interfaces which communicate with host computer subsystem 113 may periodically or continually update scheduling information stored by host computer subsystem 113 as each business 130 adjusts it's schedule due to appointments made with the system discussed herein, other systems, or traditional methods (e.g. in person, via phone).

At block 330, host computer subsystem 113 may receive a selected coupon/appointment time from user 140 and transmit this selection at block 335. In some embodiments, each business may confirm the appointment via its own means, and update its scheduling information and retransmit the scheduling information to host computer subsystem 113. In other embodiments, host computer subsystem 113 may modify the stored scheduling information for the business 130 upon receipt of a selection of an appointment from user 140.

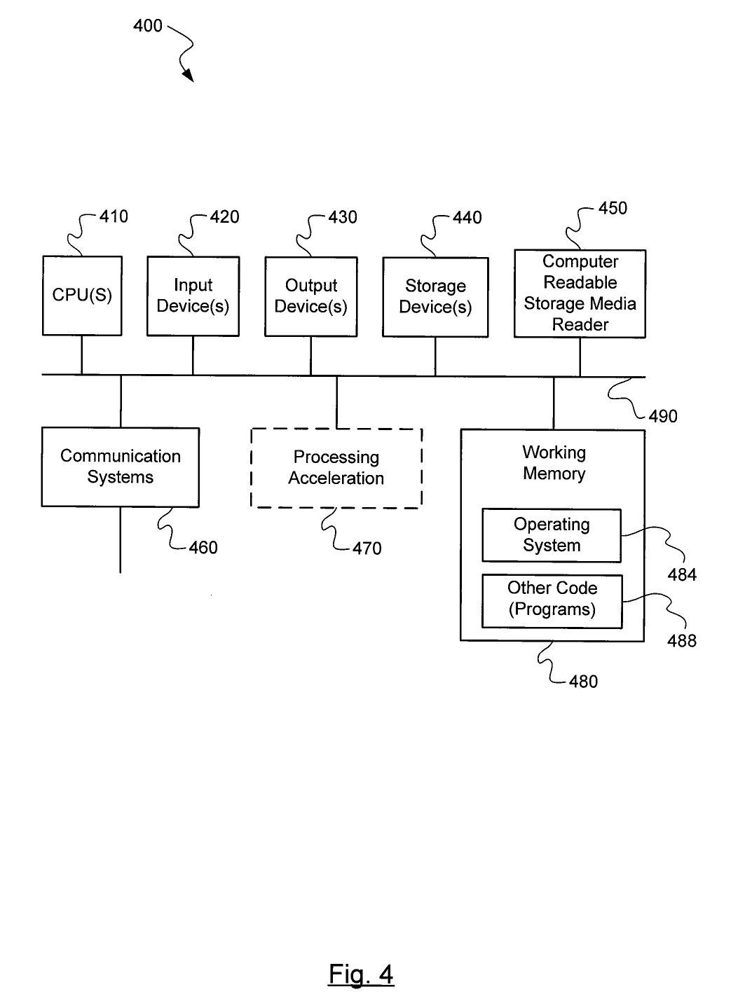

FIG. 4 is a block diagram illustrating an exemplary computer system 400in which embodiments of the present invention may be implemented. This example illustrates a computer system 400 such as may be used, in whole, in part, or with various modifications, to provide the functions of interfaces used by businesses 130, interfaces used by users 140, the host computer subsystem 113, Internet businesses 150, Internet shopping search engines 160, loyalty program system 170 and/or other components of the invention such as those discussed above. For example, various functions of centralized coupon search system 110 may be controlled by the computer system 400, including, merely by way of example, receiving information, selecting coupons based on comparisons of search requests to coupons and business 130 characteristics, communicating with Internet resources, etc.

The computer system 400 is shown comprising hardware elements that may be electrically coupled via a bus 490. The hardware elements may include one or more central processing units 410, one or more input devices 420 (e.g., a mouse, a keyboard, etc.), and one or more output devices 430 (e.g., a display device, a printer, etc.). The computer system 400 may also include one or more storage device 440. By way of example, storage device(s) 440 may be disk drives, optical storage devices, solid-state storage device such as a random access memory (“RAM”) and/or a read-only memory (“ROM”), which can be programmable, flash-updateable and/or the like.

The computer system 400 may additionally include a computer-readable storage media reader 450, a communications system 460 (e.g., a modem, a network card (wireless or wired), an infra-red communication device, Bluetooth™ device, cellular communication device, etc.), and working memory 480, which may include RAM and ROM devices as described above. In some embodiments, the computer system 400 may also include a processing acceleration unit 470, which can include a digital signal processor, a special-purpose processor and/or the like.

The computer-readable storage media reader 450 can further be connected to a computer-readable storage medium, together (and, optionally, in combination with storage device(s) 440) comprehensively representing remote, local, fixed, and/or removable storage devices plus storage media for temporarily and/or more permanently containing computer-readable information. The communications system 460 may permit data to be exchanged with a network, system, computer and/or other component described above.

The computer system 400 may also comprise software elements, shown as being currently located within a working memory 480, including an operating system 484 and/or other code 488. It should be appreciated that alternate embodiments of a computer system 400 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 400 may include code 488 for implementing any or all of the function of the various elements of the architecture as described herein. For example, software, stored on and/or executed by a computer system such as system 400, can provide the functions of interfaces used by businesses 130, interfaces used by users 140, the host computer subsystem 113, Internet businesses 150, Internet shopping search engines 160, loyalty program system 170 and/or other components of the invention such as those discussed above. Methods implementable by software on some of these components have been discussed above in more detail.

The invention has now been described in detail for the purposes of clarity and understanding. However, it will be appreciated that certain changes and modifications may be practiced within the scope of the appended claims.

What is claimed is:

1. A system for providing one or more coupons to a user, wherein the system comprises:
a host computer system;
a computer readable medium associated with the host computer system, wherein the computer readable medium comprises instructions executable by the host computer system to:
receive a characteristic information set from each of a plurality of businesses, wherein each characteristic information set includes at least one characteristic of a business;
receive a coupon set from each of the plurality of businesses, wherein each coupon set includes at least one coupon for at least one product or service;
receive a search request from a user interface, wherein the search request includes at least one characteristic or at least one identifier, and wherein the identifier represents a product or a service;
select a first coupon from a first coupon set based at least in part on a comparison of at least some portion of the search request and at least some portion of the characteristic information sets or some portion of the coupon sets; and
transmit the first coupon.

2. The system of claim 1, wherein the computer readable medium further comprises instructions executable by the host computer system to:
select a second coupon based at least in part on a comparison of at least some portion of the search request and at least some portion of the characteristic information sets or some portion of the coupon sets; and
transmit the second coupon.

3. The system of claim 2, wherein the computer readable medium further comprises instructions executable by the host computer system to:
determine a relevance of both the first coupon and the second coupon to the search request based at least in part on the comparison of at least some portion of the search request and at least some portion of the characteristic information sets or some portion of the coupon sets.

4. The system of claim 3, wherein the computer readable medium further comprises instructions executable by the host computer system to:
sort the first coupon and the second coupon based at least in part on the relevance of each; and
wherein the instructions executable by the host computer system to transmit the first coupon and the second coupon comprises instructions executable by the host computer system to transmit the first coupon and the second coupon in order of the determined relevance.

5. The system of claim 3, wherein the computer readable medium further comprises instructions executable by the host computer system to:
generate sorting information based at least in part on the determined relevance; and
transmit the sorting information.

6. The system of claim 2, wherein the system for providing one or more coupons to a user further comprises:
a user computer system; and
a computer readable medium associated with the user computer system, wherein the computer readable medium associated with the user computer system comprises instructions executable by the user computer system to:
determine a relevance of both the first coupon and the second coupon to the search request based at least in part on the comparison of at least some portion of the search request and at least some portion of the characteristic information sets or some portion of the coupon sets; and
display representations of both the first coupon and the second coupon in order of relevance on the user interface.

7. The system of claim 1, wherein the computer readable medium further comprises instructions executable by the host computer system to transmit to the user interface an Internet link associated with the business associated with the first coupon.

8. The system of claim 1, wherein the computer readable medium further comprises instructions executable by the host computer system to:
receive user information from the user interface; and
transmit the user information to at least one business.

9. The system of claim 8, wherein the user information is selected from a group consisting of:
a name;
a phone number;
a date and time;
payment information;
a selected coupon; and
a counter-offer.

10. The system of claim 1, wherein the computer readable medium further comprises instructions executable by the host computer system to:
receive consumer loyalty program information; and
select the first coupon further based at least in part on the consumer loyalty program information.

11. The system of claim 1, wherein the characteristic is selected from a group consisting of:
a name;
a location;
a schedule of operating hours;
a phone number;
an e-mail address;
a fax number; and
a web site address.

12. The system of claim 1, wherein the coupon is selected from a group consisting of:
a computer readable file including data configured to be printed in hardcopy form and presented to a business for a discount on a product or a service;
a computer readable file configured to be stored on a computer readable medium and presented to a business for a discount on a product or a service;
a facsimile transmission including text or graphics configured to be presented to a business for a discount on a product or a service;
a computer readable file configured to be received by a business for a discount on a product or a service; and
a facsimile transmission configured to be received by a business for a discount on a product or a service.

13. A method for providing at least one coupon to a user, wherein the method comprises:
receiving a characteristic information set from each of a plurality of businesses, wherein each characteristic information set includes at least one characteristic of a business;
receiving a coupon set from each of the plurality of businesses, wherein each coupon set includes at least one coupon for at least one product or service;
receiving a search request from a user interface, wherein the search request includes at least one characteristic or at least one identifier, and wherein the identifier represents a product or a service;
selecting a first coupon based at least in part on a comparison of at least some portion of the search request and at least some portion of the characteristic information sets or some portion of the coupon sets; and
transmitting the first coupon.

14. The method for providing at least one coupon to a user of claim 13, wherein the method further comprises:
selecting a second coupon based at least in part on a comparison of at least some portion of the search request and at least some portion of the characteristic information sets or some portion of the coupon sets; and
transmitting the second coupon.

15. The method for providing at least one coupon to a user of claim 14, wherein the method further comprises:
determining a relevance of both the first coupon and the second coupon to the search request based at least in part on the comparison of at least some portion of the search request and at least some portion of the characteristic information sets or some portion of the coupon sets.

16. The method for providing at least one coupon to a user of claim 15, wherein the method further comprises:
sorting the first coupon and the second coupon based at least in part on the relevance of each; and
displaying representations of both the first coupon and the second coupon in order of relevance on the user interface.

17. The method for providing at least one coupon to a user of claim 13, wherein the method further comprises selecting the first coupon further based at least in part on consumer loyalty program information provided by the user.

18. A method for providing at least one coupon to a user and arranging appointments for the user, wherein the method comprises:
receiving a characteristic information set from each of a plurality of businesses, wherein each characteristic information set includes at least one characteristic of a business;
receiving a coupon set from each of the plurality of businesses, wherein each coupon set includes at least one coupon for at least one product or service;
receiving a scheduling information set from each of the plurality of businesses, wherein each scheduling information set includes dates and times;
receiving a search request from a user interface, wherein the search request includes:
at least one characteristic or at least one identifier, wherein the identifier represents a product or a service;
a date; and
a time;
selecting a first coupon based at least in part on a comparison of:
the date;
the time; and
the characteristic or the identifier; and
transmitting the first coupon.

19. The method for providing at least one coupon to a user and arranging appointments for the user of claim 18, further comprising:
storing the scheduling information sets;
receiving updated scheduling data from a business; and
modifying at least a portion of scheduling information associated with the business based at least in part on the updated scheduling data.

20. The method for providing at least one coupon to a user and arranging appointments for the user of claim 18, wherein the scheduling information is representative of dates and times when a business is able to provide a good or service to the user.
